(19) United States
(12) Patent Application Publication
(10) Pub. No.: US 2018/0368359 A1
(43) Pub. Date: Dec. 27, 2018

(54) Invention refers to improvements to a typical horse I.D. system by providing a quick and convenient tool for attaching emergency contact information to a horse in case of an emergency.

(71) Applicant: Dan Seidlitz, Grass Valley, CA (US)

(72) Inventor: Dan Seidlitz, Grass Valley, CA (US)

(21) Appl. No.: 15/630,947

(22) Filed: Jun. 22, 2017

(51) Int. Cl. A01K 11/00; G09F 3/16

(52) U.S. Cl. CPC A01K 11/00; G09F 3/16

(57) ABSTRACT

The primary object of the present invention, which is comprised of a plastic triangular sharped housing, a finger plunger, a compression spring and a hair clamp is to provide an improved horse I.D. tag system. In addition, the clip-on tag device securely grasps strands of hair by having a sliding action by movement of a finger plunger with a mechanical spring located in a plastic triangular sharped housing. More particularly, this invention is directed to an staggered sequence of plastics ribs and teeth located at the inner surface of the hair clamp for more securely holding the hair strands between the hair clamp and housing.

### STATEMENT REGARDING FEDERALLY SPONSORED RESEARCH OR DEVELOPMENT

Not Applicable

### REFERENCE TO A “MICROFICHE APPENDIX”

Not Applicable.

### FIELD OF THE INVENTION

This invention refers to improvements to a typical horse I.D. system by providing a quick and convenient tool for attaching emergency contact information to a horse in case of an emergency.

### BACKGROUND OF THE INVENTION

Catastrophic weather-related events—floods, wildfires, hurricanes, and storms—can have a devastating effect on horses as well as humans. Every year in the United States, more than 300,000 people are driven from their homes by floods. During the 2007 California wildfires, more than 1 million people and thousands of horses were evacuated. During the annual hurricane season, thousands of horses either die or are evacuated.

Some of the disasters that horse owners may face are tornadoes, thunderstorms, electrical storms, ice storms, floods, flash floods, earthquakes, windstorms, and fire. Nobody expects to be the victim of a weather-related emergency, and so they may not be prepared when they find themselves in the midst of such an emergency.

One of the greatest costs of not being prepared is that owners may never find their animals again after a disaster. In addition, lack of preparedness puts undue strain on a rescue team, as they are faced with unmarked, untamed, and potentially unwanted horses. As a horse owner, you have the primary responsibility to plan ahead for how you will care for your horses and not rely on rescue organizations.

There are different types humane methods of identification including an ID tag attached to the horse's halter, neck collars, leg band and livestock marking. Sometimes horses lose their halters, and neck collars and/or leg bands would have to be pre-addressed with the owner's contact information and strapped around the neck or leg of the horse before any disaster strikes.

Yet another way to identify your horse is to write your name, address, cell phone & email on white ribbons that you braid into your horse's mane and/or tail. However, these methods are time consuming and in some case uncomfortable for horses.

We have seen it on the news: earthquakes and tornadoes and the damage they can cause. When these unexpected events occur, casualties and injuries are inevitable. You can be prepared to maintain organization during a mass casualty incident with emergency clip-on tag device.

### DETAILED DESCRIPTION OF THE INVENTION

The object of the present invention to provide an improved tagging system for horses in case of an emergency situation. Clip-on tag device is a quick and convenient tool for storing emergency contact information by replacing existing time-consuming methods of identification.

The invention is rugged enough for the military and makes ideal emergency contact information for any type of pets or livestock. This handy invention is designed to tightly close and keep hair content in place for days. The invention is easy to use; just close the clip around multiple strands of hair and release—similar function as a hair barrette.

To use the clip-on tag device, simply press down on the top to open the device. You will notice that a wide opening is created, and the interior of the opening features a jagged edge. These teeth will help to grip the hair, and create a strong seal. They will prevent slippage, and help keep the emergency information intact.

Since the concern is the safe return of your horse during a disaster, the invention provides a fast and easy way to attach vital information to your horse. Thanks to a clever design and quality construction, the invention can attach to either the mane or the tail of the horse without falling off. In addition, horses with their ID's in their manes and tails were easy to spot.

Just squeeze the clip and grip onto the horse's mane or tail and twist the tag for a tight seal. The generously sized non-slip pads on ends make for a secure soft grip. Plastic ribs and teeth on the inside of the clip-on tag device hold hair securely.

Clip-on tag device is an emergency I.D. holding device constructed of fire-resistant plastic with a fire-resistant custom identification tag. The invention components can be manufactured by any fabrication facility and can be mass produced using a CNC machine or rapid prototyping devices. Each of the following components, clip-on tag device housing, clip-on tag device hair clamp and clip-on tag device plunger can be made out of durable fire-resistant plastics and assembled by hand.

### BRIEF DESCRIPTION OF THE DRAWING

FIG. 1 is substantially a perspective view of clip-on tags device system incorporated in the present invention.

FIG. 1A is a side view of the clip-on tags device in the closed state of the present invention.

FIG. 1B is a side view of the clip-on tags device in the open state of the present invention.

FIG. 2 is a close-up perspective view of the clip-on tags device incorporated in the present invention.

FIG. 3 is substantially an exploded view of the relationship between components of the present invention.

FIG. 4 is a cross section view of the relationship between components, in the closed position, of the present invention.

FIG. 4A is a cross section view of the relationship between components, in the open position, of the present invention.

FIG. 5 is a perspective view of the clip-on clamp of the present invention.

FIG. 5A is a close-up perspective view of the clip-on clamp showing the ribbed of the present invention.

FIG. 5B is a cut-a-way view of the clip-on clamp showing the teeth of the present invention.

FIG. 6 is a perspective view of the finger plunger and hair clamp assembly in the pre-attached position, of the present invention.

FIG. 6A is a perspective view of the finger plunger and hair clamp assembly in the attached position, of the present invention.

FIG. 7 is cut-a-way view of the clip-on plunger snap mount cantilever and clip-on clamp counterpart in the attached position, of the present invention.

FIG. 7A is a close-up view of the hair clamp counterpart of the present invention.

FIG. 7B is a close-up view of the finger plunger snap mount cantilever of the present invention.

### DESCRIPTION OF CERTAIN EMBODIMENT OF THE PRESENT INVENTION

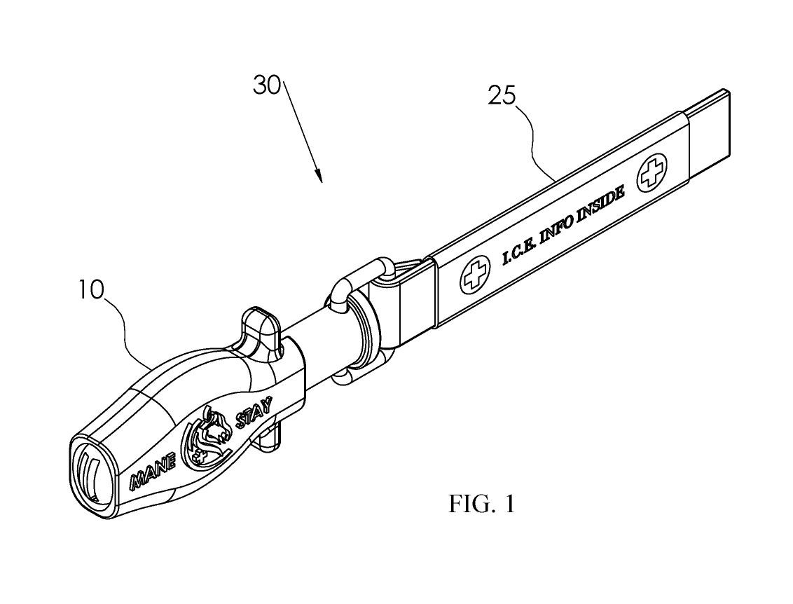

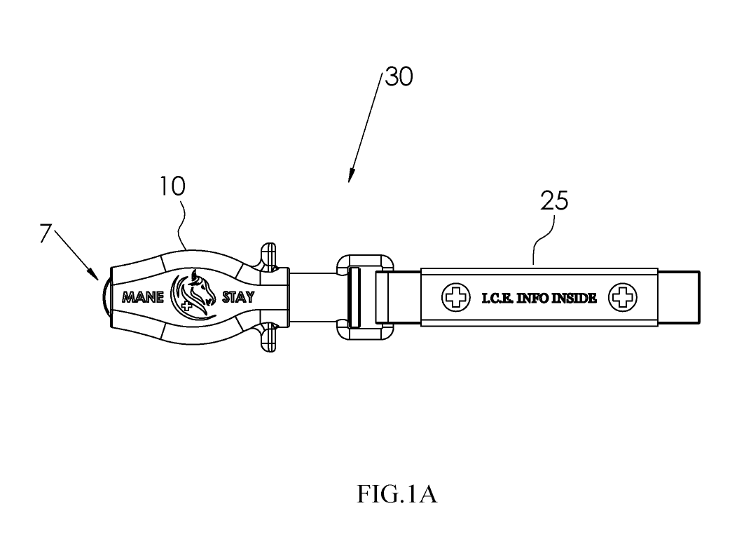

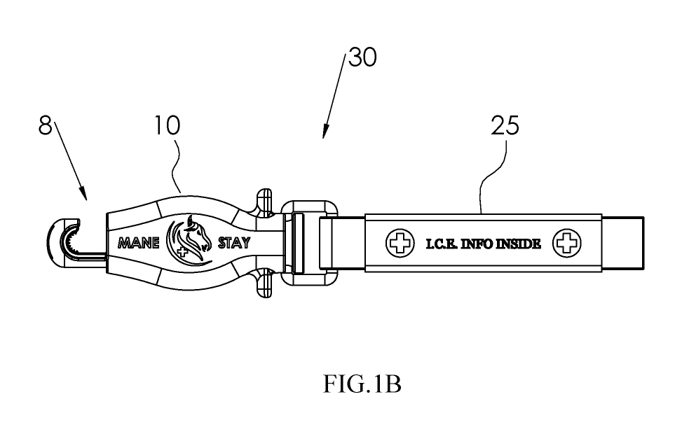

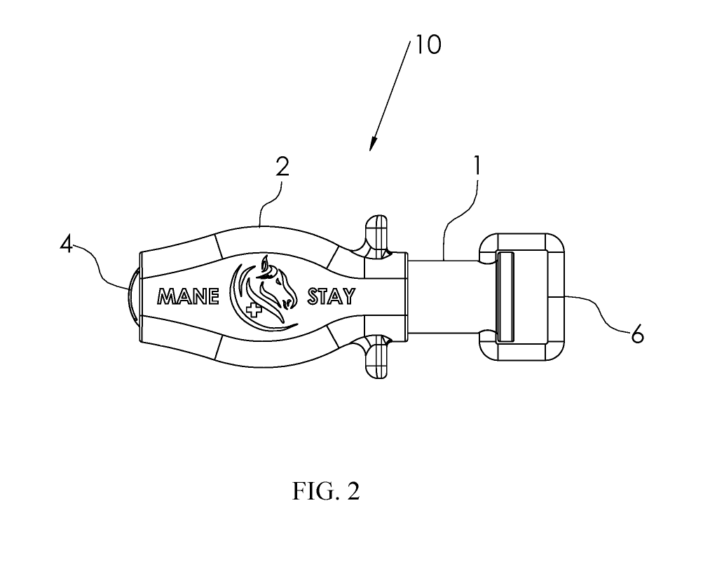

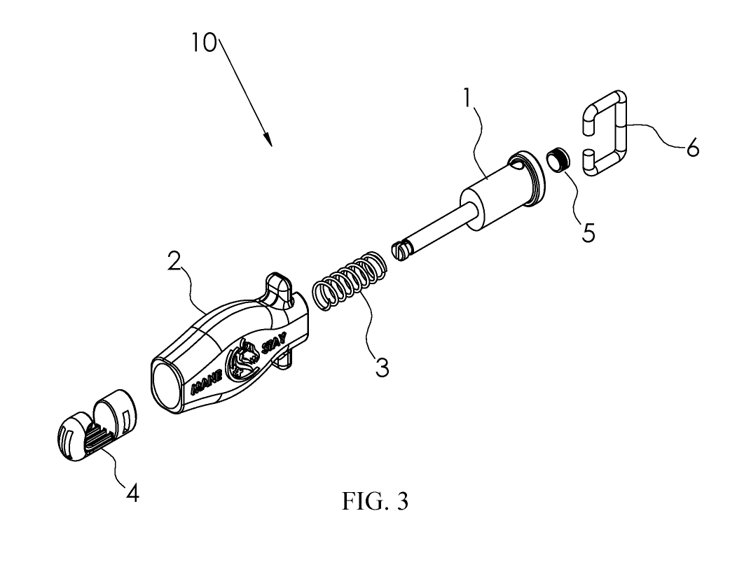

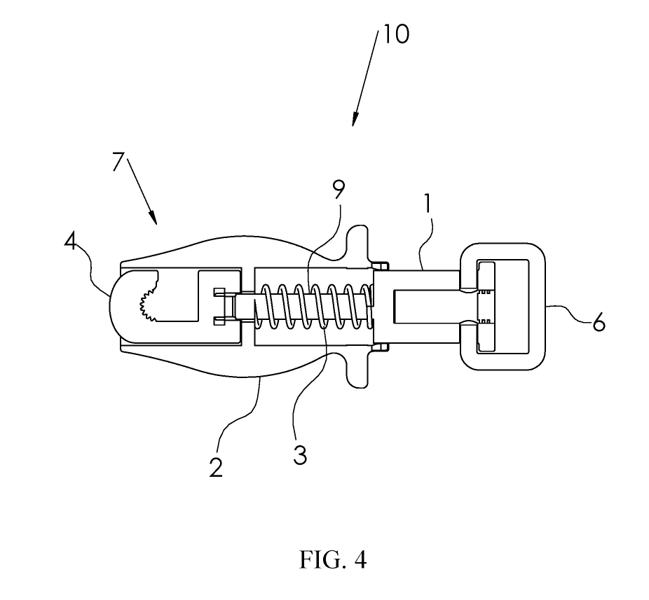

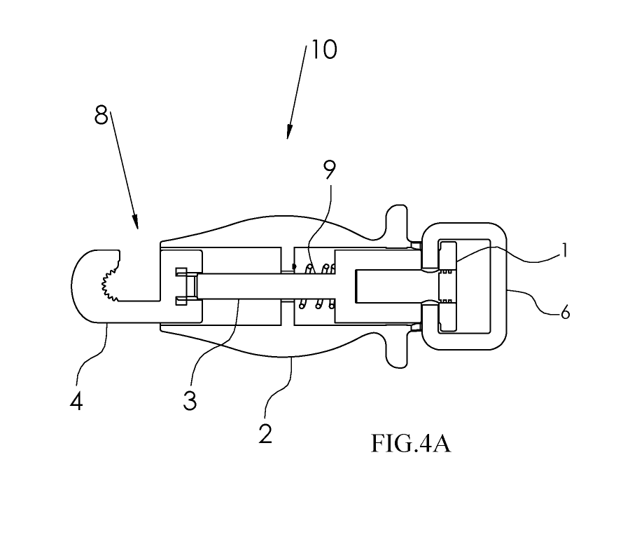

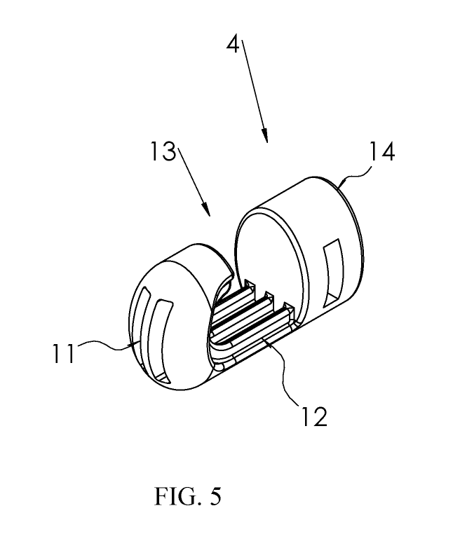

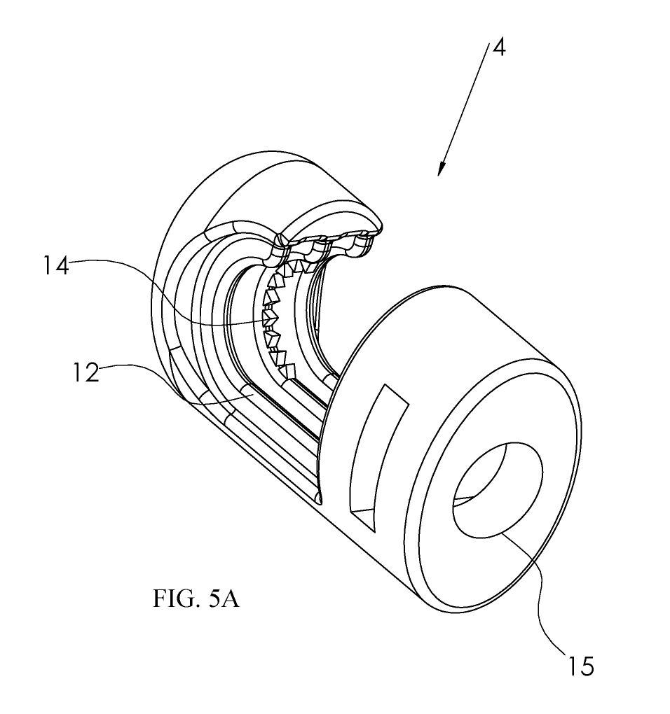

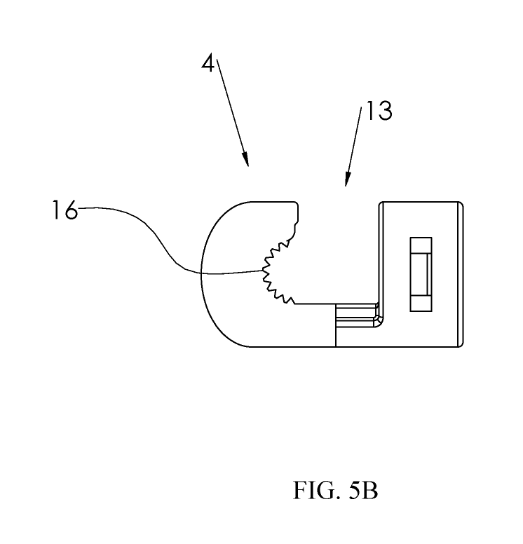

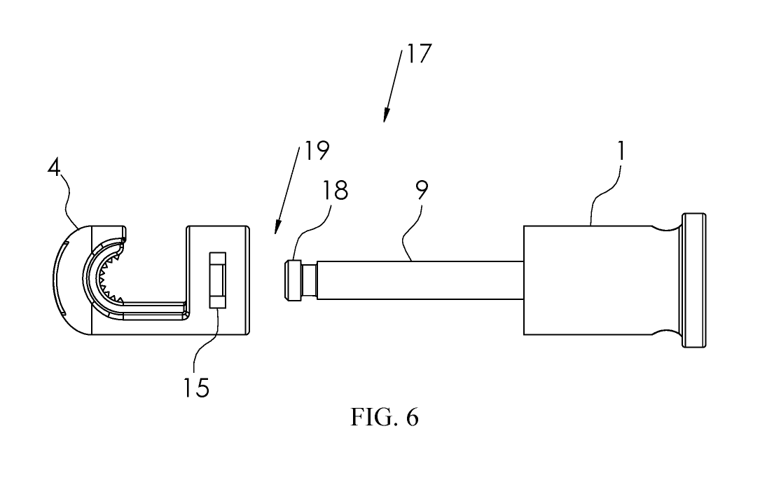

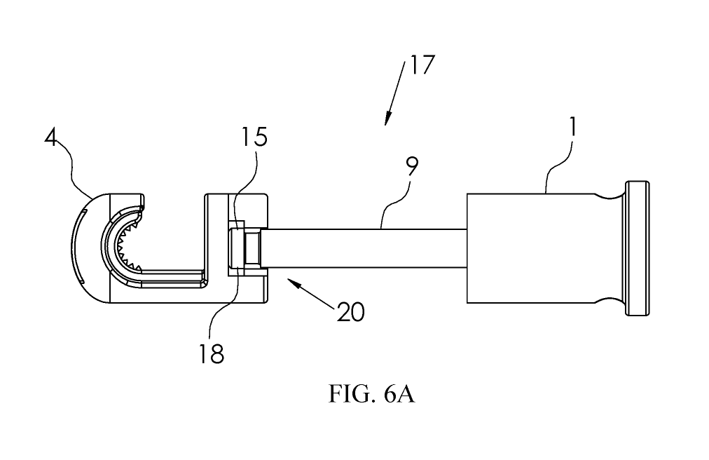

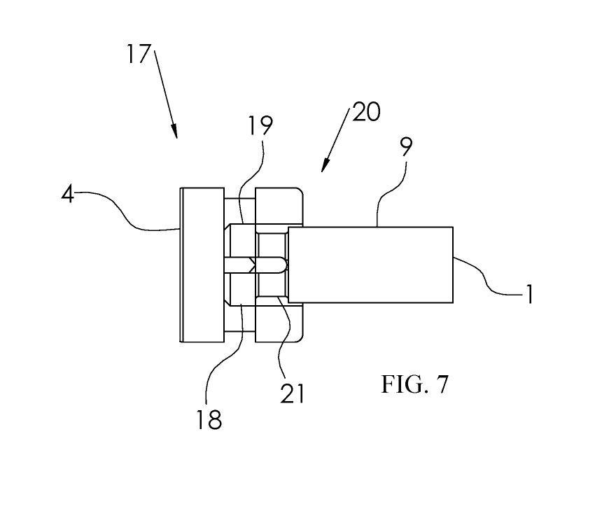

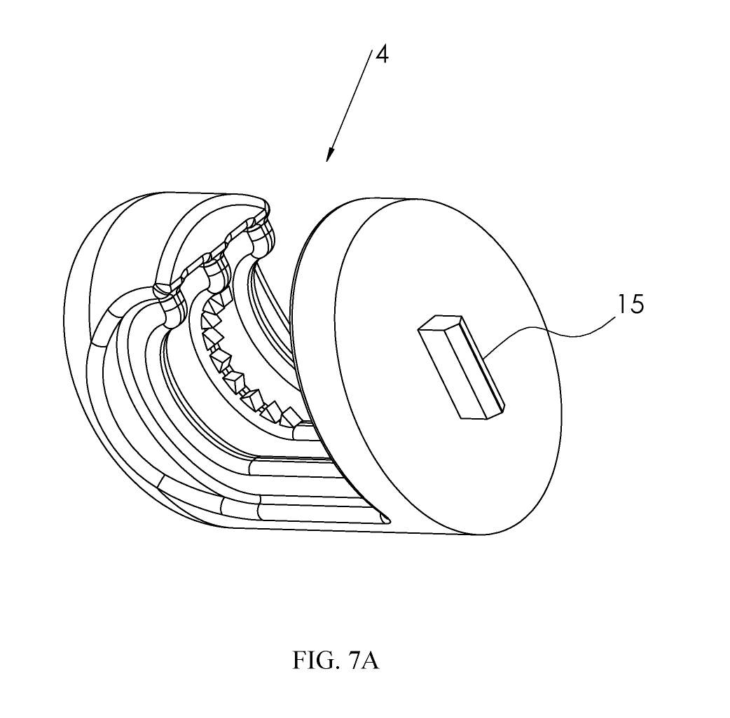

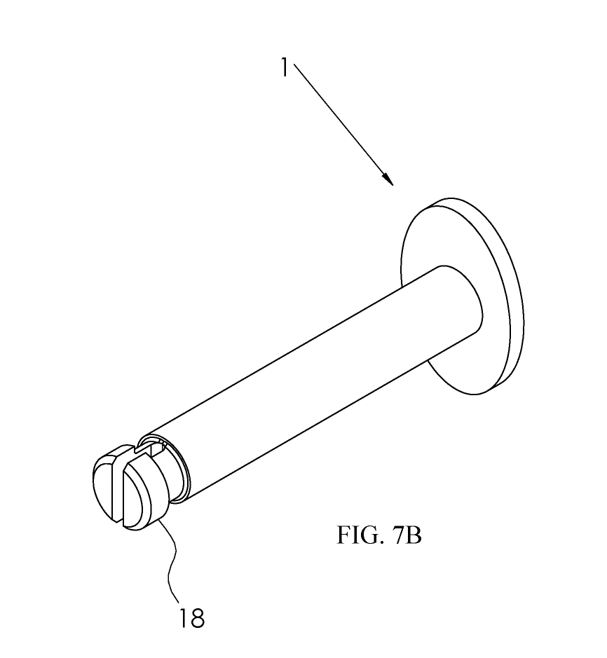

In the following detailed description of the preferred embodiment, reference is made to the accompanying drawings, which form a part of this application. The drawings show, by way of illustration, specific embodiments in which the invention may be practiced. It is to be understood that other embodiments may be utilized and structural changes may be made without departing from the scope of the present invention. The present invention shown in FIG. 1 is a perspective view of the Clip-on Tag Device system 30 with the clip-on Tag device 10 including an I.C.E. Mane-Stay clip-on identification tag 25. As substantially shown in FIG. 1A is the Clip-on Tag Device system 30 with the clip-on Tag device 10 including an I.C.E. Mane-Stay clip-on identification tag 25 in the closed state 7 of the present invention. Moreover, as shown in FIG. 1B is the Clip-on Tag Device system 30 with the clip-on Tag device 10 including an I.C.E. Mane-Stay clip-on identification tag 25 in the open state 8 of the present invention. As generally shown in FIG. 2 is close-up side view of a preferred embodiment of the clip-on Tag device 10, which could comprise of a housing body 2, a finger plunger 1 with a tag ring 6, and a hair clamp 4 in accordance with the present invention. As substantially shown FIG. 3, an exploded view of the clip-on Tag device 10 includes a finger plunger 1, a housing body 2, a compression spring 3 and hair clamp 4. As generally shown in FIG. 4 is cross section view of the relationship between clip-on Tag device 10 components, including finger plunger 1 with a tag ring 6, a housing body 2 with a compression spring 3 attached to the plunger shaft and a hair clamp 4 in the closed position 7. Moreover, as shown in FIG. 4A is cross section view of the relationship between clip-on Tag device 10 components, including finger plunger 1 with a tag ring 6, a housing body 2 with a compression spring 3 attached to the plunger shaft and a hair clamp 4 in the closed position 8. As generally shown in FIG. 5 is a perspective view of the hair clamp 4 of the present invention, comprised a top opening vent 11, an hair slot opening 13 with a clamp ribs 12 section. As substantially shown FIG. 5A is a close-up perspective view of the hair clamp 4 of the present invention showing the clamp ribs 12 with the clamp teeth 14 located on the center rib. Moreover, as shown in FIG. 5B is a cut-a-way view of the hair clamp 4 of the present invention showing the clamp teeth 14 located within the clamp opening 13. As generally shown in FIG. 6, the finger plunger and hair clamp assembly 17 in the pre-attached position 19 including the finger plunger 1 with the snap mount cantilever 18 built into the end of the plunger shaft 9 and hair clamp 4 with the snap mount counterpart 15 in the pre-snap attachment position. As substantially shown FIG. 6A the finger plunger and hair clamp assembly 17 in the attached position 20 including the finger plunger 1 with the snap mount cantilever 18 built into the end of the plunger shaft 9 and hair clamp 4 with the snap mount counterpart 15 in the snap attachment position. As best seen in FIG. 7, a cut-a-way view of the finger plunger and hair clamp assembly 17 in the attached position 20, showing the finger plunger 1 with the snap mount cantilever 18 built into the end of the plunger shaft 9 attached to the hair clamp 4 snap mount counterpart 15 within the locking slot 21. As substantially shown FIG. 7A is a perspective view of the hair clamp 4 of the present invention showing a close-up view of the snap mount counterpart 15. Moreover, as shown in FIG. 7B is a perspective view of finger plunger 1 of the present invention showing a close-up view of the snap mount cantilever 18.

What claimed is:

1. A clamping clip-on tag device having an opening comprising a hair clamp consisting of plastics ribs and teeth located at the inner surface of the hair clamp for holding the hair strands between the hair clamp and housing.
(A) A plastic triangular sharped housing, a finger plunger, a compression spring and hair clamp securely grasp strand of hair by having a sliding action by movement of the finger plunger. The rib teeth clamp on one end thereof, said housing having on the opposite end to said clamp, a finger plunger having a round shaft on one end of the plunger slidable in said housing cavity support a compression spring seat in same end as the plunger. Said clamp and plunder connected together for relative sliding movement.

2. The clip-on tag device as recited in claim 1, wherein clip-on member comprising a plastic triangular sharped housing having a tip and a base, the tip having a cavity for housing the clamp while the base having a cavity for housing the plunger. Said housing including a solid rib with a clearance hole located within the housing body.

3. The clip-on tag device as recited in claim 2, wherein the clamp is push by the plunger mechanism to move against the spring and move the clamp to an open position.

4. The clip-on tag device as recited in claim 3, includes the plunger shaft, and housing inter wall structure for controlling the compression spring movement when engaged by the finger plunger.

5. The clip-on tag device as recited in claim 4, the compression spring works by keeping pressure on the clamp in the closed position.

6. The clip-on tag device as recited in claim 4 wherein the finger plunger and hair clamp attached by a snap mount cantilever built into the end of the plunger shaft and attached to snap mount counterpart.
